(19) United States
(12) Patent Application Publication
(10) Pub. No.: US 2026/0102931 A1
(43) Pub. Date: Apr. 16, 2026

(54) VEHICLE COMPONENT GRABBER ASSEMBLY

(71) Applicant: GM Global Technology Operations LLC, Detroit, MI (US)

(72) Inventor: Dooil Hwang, Rochester Hills, MI (US)

(21) Appl. No.: 18/914,791

(22) Filed: Oct. 14, 2024

(51) Int. Cl. B25J 15/06

(52) U.S. Cl. CPC B25J 15/0683

(57) ABSTRACT

A grabber assembly defines a first axis, a second axis perpendicular to the first axis, and a third axis perpendicular to the first axis and the second axis, and includes a shaft extending along the third axis and defining a through-hole therein extending along the third axis, a suction head assembly disposed on the shaft and comprising a suction head configured to form a seal against a surface of a vehicle component, the suction head being fluidly coupled to the through-hole of the shaft, and a brake assembly movably supporting the shaft such that the shaft is movable along the third axis, the brake assembly comprising a braking structure that is configured to selectively immobilize the shaft along the third axis.

### INTRODUCTION

The subject disclosure relates to vehicles, and in particular to a grabber assembly for a vehicle component.

During vehicle manufacturing, a vehicle component may be carried by a carrier assembly coupled to a robot arm for transporting the vehicle component and/or performing tasks on the vehicle component. Improvements in carrier assemblies may be desirable.

### SUMMARY

In one exemplary embodiment, a grabber assembly defines a first axis, a second axis perpendicular to the first axis, and a third axis perpendicular to the first axis and the second axis, and comprises a shaft extending along the third axis and defining a through-hole therein extending along the third axis, a suction head assembly disposed on the shaft and comprising a suction head configured to form a seal against a surface of a vehicle component, the suction head being fluidly coupled to the through-hole of the shaft, and a brake assembly movably supporting the shaft such that the shaft is movable along the third axis. The brake assembly comprises a braking structure that is configured to selectively immobilize the shaft along the third axis.

In addition to one or more of the features described herein, the grabber assembly further comprises a biasing member disposed between the suction head assembly and the brake assembly and configured to bias the suction head assembly away from the suction head assembly along the third axis.

In addition to one or more of the features described herein, the biasing member is a coil spring disposed around the shaft.

In addition to one or more of the features described herein, the through-hole of the shaft is fluidly coupled to a fluid suction mechanism that generates a vacuum force within the suction head.

In addition to one or more of the features described herein, the braking structure comprises a brake shoe disposed around the shaft and a brake driver disposed at least partially around the brake shoe.

In addition to one or more of the features described herein, the grabber assembly defines a radial direction perpendicular to the third axis, the brake driver is movable along the third axis while immobile along the radial direction, and the brake shoe is movable along the radial direction while immobile along the third axis.

In addition to one or more of the features described herein, the brake driver comprises a driving surface, the brake shoe comprises a driven surface, and the driving surface is configured to press against the driving surface when the brake driver moves along the third axis.

In addition to one or more of the features described herein, the driving surface and the driven surface are inclined with respect to the third axis.

In addition to one or more of the features described herein, the brake shoe comprises a braking surface that faces the shaft and that is configured to push against the shaft along the radial direction to immobilize the shaft along the third axis.

In addition to one or more of the features described herein, the brake driver is coupled to an actuation mechanism configured to move the brake driver along the third axis.

In addition to one or more of the features described herein, the suction head is shaped as bellows.

In addition to one or more of the features described herein, the suction head assembly further comprises a pivot plate that is rotatably mounted on the shaft via a swivel joint.

In addition to one or more of the features described herein, the pivot plate is rotatable about the second axis.

In addition to one or more of the features described herein, the grabber assembly further comprises a controller configured to control the fluid suction mechanism and the braking structure.

In addition to one or more of the features described herein, the brake assembly comprises a brake housing in which the braking structure is mounted.

In another exemplary embodiment, a carrier assembly defines a first axis, a second axis perpendicular to the first axis, and a third axis perpendicular to the first axis and the second axis, and comprises a carrier frame comprising a beam extending along the first axis and a grabber bracket extending from the beam along the second axis, and a grabber assembly mounted on the grabber bracket. The grabber assembly comprises a shaft extending along the third axis and defining a through-hole therein extending along the third axis, a suction head assembly disposed on the shaft and comprising a suction head configured to form a seal against a surface of a vehicle component, the suction head being fluidly coupled to the through-hole of the shaft, and a brake assembly movably supporting the shaft such that the shaft is movable along the third axis. The brake assembly comprises a braking structure that is configured to selectively immobilize the shaft along the third axis.

In addition to one or more of the features described herein, the brake assembly comprises a brake housing in which the braking structure is mounted, the brake housing being mounted directly on the grabber bracket.

In addition to one or more of the features described herein, the shaft is movable along the third axis with respect to the carrier frame.

In yet another exemplary embodiment, a carrier assembly comprises a carrier frame comprising a first beam and a second beam extending along the first axis and spaced from each other along the second axis, a first grabber bracket and a second grabber bracket extending from the first beam along the second axis and spaced from each other along the first axis, and a third grabber bracket and a fourth grabber bracket extending from the second beam along the second axis and spaced from each other along the first axis, a first grabber assembly mounted on the first grabber bracket, a second grabber assembly mounted on the second grabber bracket, a third grabber assembly mounted on the third grabber bracket, and a fourth grabber assembly mounted on the fourth grabber bracket, each of the first, second, third and fourth grabber assemblies comprising: a shaft extending along the third axis and defining a through-hole therein extending along the third axis, a suction head assembly disposed on the shaft and comprising a suction head shaped as a bellows configured to form a seal against a surface of a vehicle component, the suction head being fluidly coupled to the through-hole of the shaft, a brake assembly movably supporting the shaft such that the shaft is movable along the third axis, the brake assembly comprising a brake housing and a braking structure mounted in the brake housing that is configured to selectively immobilize the shaft along the third axis, and a coil spring disposed around the shaft between the suction head assembly and the brake assembly and configured to bias the suction head assembly away from the suction head assembly along the third axis. The braking structure comprises a brake shoe disposed around the shaft and a brake driver disposed at least partially around the brake shoe. The grabber assembly defines a radial direction perpendicular to the third axis. The brake driver is movable along the third axis while immobile along the radial direction. The brake shoe is movable along the radial direction while immobile along the third axis. The brake driver comprises a driving surface, the brake shoe comprises a driven surface, and the driving surface is configured to press against the driving surface when the brake driver moves along the third axis. The driving surface and the driven surface are inclined with respect to the third axis. The brake shoe comprises a braking surface that faces the shaft and that is configured to push against the shaft along the radial direction to immobilize the shaft along the third axis. The suction head assembly further comprises a pivot plate that is rotatably mounted on the shaft via a swivel joint so as to be rotatable about the second axis.

In addition to one or more of the features described herein, the through-hole of the shaft is fluidly coupled to a fluid suction mechanism that generates a vacuum force within the suction head, the brake driver is coupled to an actuation mechanism configured to move the brake driver along the third axis, and the carrier assembly further comprises a controller configured to control the fluid suction mechanism and the actuation mechanism.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a side view of a vehicle having vehicle components according to one or more embodiments;

FIG. 2 is a perspective view of a grabber assembly of a carrier assembly for a vehicle component coupled to a robot arm assembly and carrying a vehicle component according to one or more embodiments;

FIG. 3 is a front view of a grabber assembly according to one or more embodiments; and

FIG. 4. is a schematic view of the grabber assembly according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

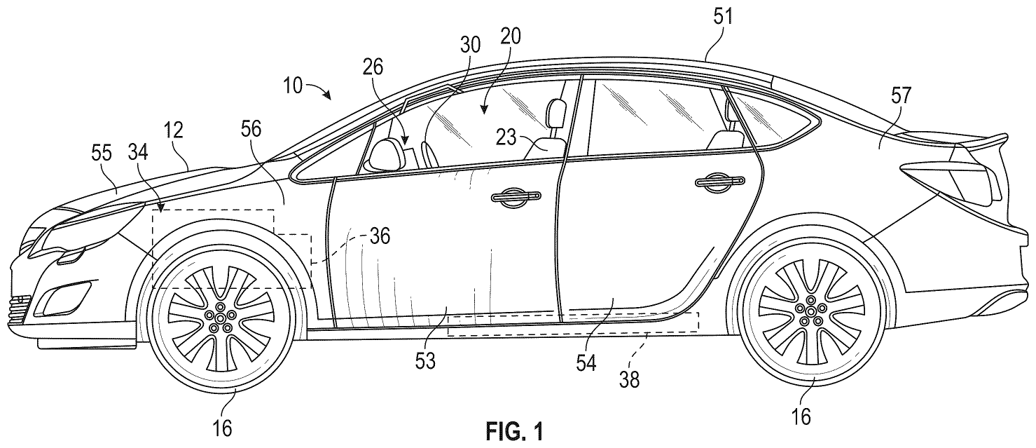

FIG. 1 shows a vehicle 10 according to a non-limiting example. The vehicle 10 includes a vehicle body 12 supported on a plurality of wheels 16. The vehicle body 12 defines, in part, a passenger compartment 20 including a driver seat 23, dashboard 26, and a steering wheel 30. One or more of the wheels 16 may be steerable via the steering wheel 30. The vehicle body 12 further defines, in part, a prime mover compartment that houses a prime mover 34. The prime mover 34 may be, for example, an engine, a motor, or both an engine and a motor in a hybrid configuration. A rechargeable energy storage system (RESS) may be arranged in the vehicle body 12 and may provide power to components within the vehicle 10 (e.g., the prime mover 34). As a non-limiting example, the rechargeable energy storage system may include a battery assembly 38. A gear assembly and/or transmission 36 may be coupled to the prime mover 34 to drive one or more of the wheels 16. While specific locations are shown for the prime mover 34, the gear assembly and/or transmission 36, and the battery assembly 38 in FIG. 1, these locations are merely exemplary and not limiting, and locations of these structures may vary.

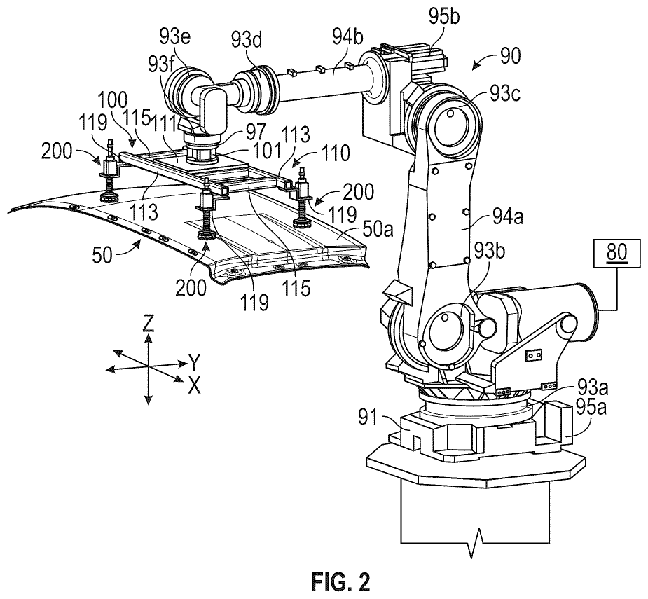

The vehicle body 12 may further include a roof with a roof outer panel 51, one or more front doors with a front door outer panel 53, one or more rear doors with a rear door outer panel 54, a hood with a hood outer panel 55, a fender panel 56, and a quarter panel 57. The roof outer panel 51, the front door outer panel 53, the rear door outer panel 54, the hood outer panel 55, the fender panel 56, and the quarter panel 57 are examples of a vehicle component 50 (see FIG. 2) according to one or more embodiments. However, the vehicle component 50 is not limited thereto.

FIG. 2 shows a grabber assembly 200 of a carrier assembly 100 coupled to a robot arm assembly 90 and carrying a vehicle component 50 according to one or more embodiments. The robot arm assembly 90 includes a base 91, a plurality of rotation mechanisms 93a, 93b, 93c, 93d, 93e, 93f, a plurality of arms 94a, 94b, a plurality of motors 95a, 95b, and a plurality of motors 95a, 95b that may drive one or more of the rotation mechanisms 93a, 93b, 93c, 93d, 93e, 93f, and may terminate at a free end 97.

A carrier assembly 100, which may be an end effector according to one or more embodiments, may be disposed on a free end 97 of the robot arm assembly 90. Specifically, a carrier base 101 of the carrier assembly 100 may be attached to the free end 97 of the robot arm assembly 90 such that the robot arm assembly 90 may move the carrier assembly 100 along multiple degrees of freedom provided by the rotation mechanisms 93a, 93b, 93c, 93d, 93e, 93f.

The carrier assembly 100 defines a first axis X, a second axis Y perpendicular to the first axis X, and a third axis Z perpendicular to the first axis X and the second axis Y. The carrier assembly 100 may include a carrier frame 110 attached to a bottom surface of the carrier base 101, and a plurality of grabber assemblies 200 coupled to the carrier frame 110. The grabber assemblies 200 are configured to grab a surface 50a of the vehicle component 50. While the embodiment shown in FIG. 2 includes four grabber assemblies 200, the present disclosure is not limited thereto.

The robot arm assembly 90 or the carrier assembly 100 may include a controller 80 configured to control the robot arm assembly 90 and/or the grabber assemblies 200. The controller 80 may be a single controller or multiple controllers. The controller 80 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 80 may be or include a robot controller.

The carrier frame 110 may include an attachment base 111 that is attached to the carrier base 101, and a pair of first beams 113 extending along the first axis X and attached to sides of the attachment base 111 along the second axis Y. A pair of second beams 115 extend between the first beams 113. The carrier frame 110 may further include a plurality of grabber brackets 119.

The carrier assembly 100 may include linear actuator assemblies and clamp assemblies as disclosed in U.S. patent application Ser. No. 18/914,712, filed with the United States Patent and Trademark Office on Oct. 14, 2024, the contents of which are incorporated by reference herein in their entirety. While the clamp assemblies may bear the weight of the vehicle component 50, the size of the vehicle component 50 along the first axis X may be relatively large relative to a thickness thereof along the third axis Z, which may result in a central portion of the vehicle component 50 sagging due to gravitational forces. To counteract the sagging, the carrier assembly 100 includes grabber assemblies 200 to grab the surface 50a of the vehicle component 50 via vacuum forces.

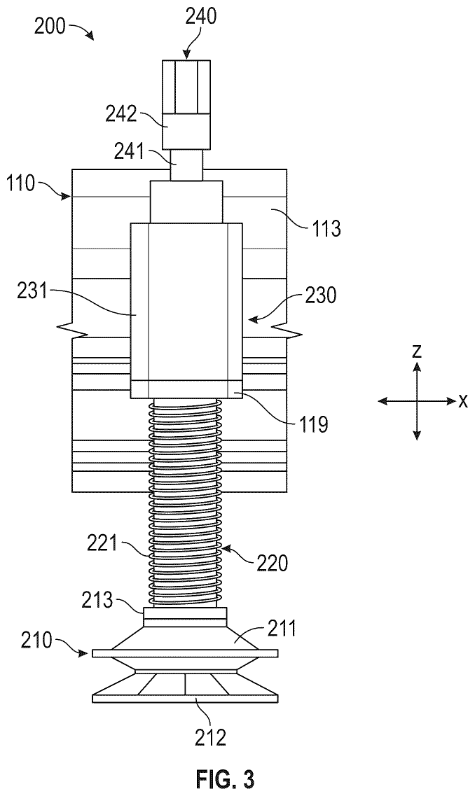

Referring now to FIGS. 2, 3, and 4, each of the grabber assemblies 200 includes a suction head assembly 210, a biasing member assembly 220, a brake assembly 230, and a shaft assembly 240.

The shaft assembly 240 includes a shaft 241 that has a first through-hole 243 extending therethrough along the third axis Z. The shaft 241 may have an upper end 242 that has a larger diameter than a remainder of the shaft 241. The upper end 242 of the shaft 241 may be fluidly coupled to a fluid suction mechanism 260.

The fluid suction mechanism 260 may be, for example, a pump or a blower. The upper end 242 of the shaft 241 of each of the grabber assemblies 200 may be coupled to a separate fluid suction mechanism 260 or a single common fluid suction mechanism 260. The fluid suction mechanism 260 may be controlled by the controller 80 to turn the fluid suction mechanism 260 on and off, and/or to adjust the suction level at the fluid suction mechanism 260.

The suction head assembly 210 includes a suction head 211 mounted on a lower side of a pivot plate 213. The pivot plate 213 includes an upper surface 214. The suction head 211 may be formed of a deformable material. As non-limiting examples, the suction head 211 may be formed of rubber or silicone. The suction head 211 includes a sealing end 212 configured to abut against the surface 50a of the vehicle component 50 to form a seal therebetween. The pivot plate has a second through-hole 217 formed therethrough along the third axis Z that is coupled to the first through-hole 243 of the shaft 241. When the suction head 211 forms a seal against the surface 50a of the vehicle component 50, the suction forces from the fluid suction mechanism 260 may vacate air from within the suction head 211 through the pivot plate 213 and the shaft 241.

The vehicle component 50 may have a surface 50a that is an uneven surface. According to one or more embodiments, the suction head 211 may be structured as a bellows such that the suction head 211 is able to deform, allowing the sealing end 212 to form the seal against uneven surfaces. The suction head 211 may be structured to be flexible and/or collapsible.

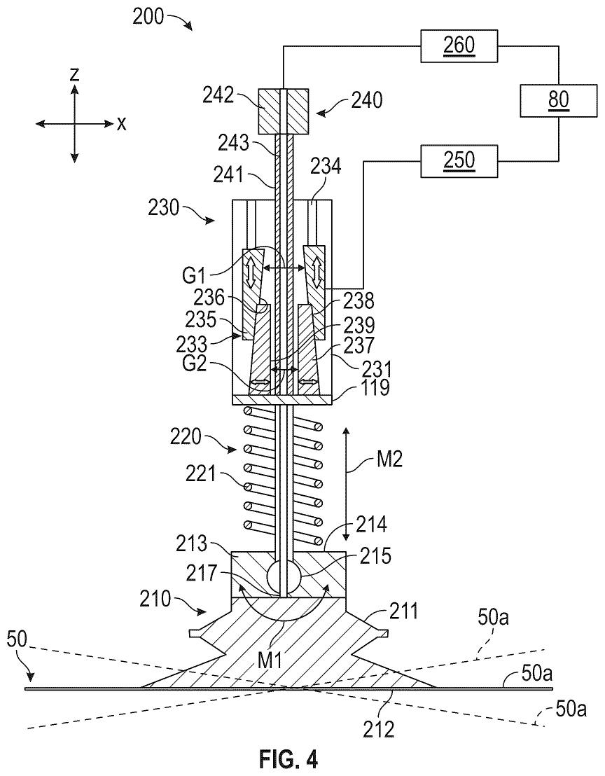

The vehicle component 50 may have a surface 50a that is an inclined surface. The pivot plate 213 may be rotationally mounted on the shaft 241 via a swivel joint 215 so as to allow the pivot plate 213 to rotate about the second axis Y as shown by arrow M1. The rotation of the pivot plate 213 about the swivel joint 215 also rotates the suction head 211 mounted on the pivot plate 213, allowing the suction head 211 to form the seal against inclined surfaces. Such inclined surfaces are shown in dashed lines in FIG. 4.

The brake assembly 230 includes a brake housing 231 that is mounted on the carrier frame 110 via the grabber bracket 119 extending from the first beam 113. The upper end 242 of the shaft 241 may have a larger diameter than a passage formed in an upper wall of the brake housing 231 such that the shaft 241 is prevented from falling out of the brake housing 231.

A braking structure 233 may be disposed within the brake housing 231. The braking structure 233 may include a brake shoe 237 disposed around the shaft 241 and a brake driver 235 disposed at least partially around the brake shoe 237. The brake driver may be an annular structure around the brake shoe 247 or, alternatively, may formed of segments around the brake shoe 247. The brake shoe 247 may be formed of segments and movably mounted within the brake housing 231. The brake shoe 247 may be movable inward and outward along a radial direction with respect to the brake housing 231 while immovable along the third axis Z with respect to the brake housing 231. The radial direction may extend along a plane perpendicular to the third axis Z. Bearings (not shown) may be disposed between a bottom of the brake shoe 247 and the brake housing 231 to facilitate movement of the brake shoe 247 along the radial direction.

The brake driver 235 may be movably mounted within the brake housing 231 so as to be movable axially along the third axis Z, but immovable with respect to the radial direction. As a non-limiting example, the brake driver may be movably mounted on the brake housing 231 via a mounting structure 234 that may be one or more rods or an annular structure. The brake driver 235 and/or the mounting structure 234 is coupled to an actuation mechanism 250 configured to move the brake driver 235 up and down along the third axis Z. The actuation mechanism 250 may move the brake driver 235 up and down along the third axis Z by pneumatic, hydraulic, mechanical, and/or electrical structures. The actuation mechanism 250 may be coupled to the controller 80 such that the controller 80 may control the actuation mechanism 250, either automatically or in conjunction with operator input.

The brake driver 235 includes driving surfaces 236 on an inner side thereof that is inclined with respect to the third axis Z. While driving surfaces 236 are discussed herein as a plurality, the brake driver 235 may be an annular structure having a single annular driving surface 236. The driving surfaces 236 may be inclined such that a first gap G1 between the driving surfaces 236 along the radial direction increases from an upper portion of the brake driver 235 to a lower portion of the brake driver 235.

The brake shoe 237 includes driven surfaces 238 on an outer side thereof that is inclined with respect to the third axis Z. The driven surfaces 238 may be inclined such that a distance between the driven surfaces 238 along the radial direction increases from an upper portion of the brake shoe 237 to a lower portion of the brake shoe 237. An inclination angle of the driven surface 238 may correspond to an inclination angle of the driving surface 236. According to one or more embodiments, low friction coatings may be formed on the driving surfaces 236 and/or the driven surfaces 238. According to one or more embodiments, bearings may be disposed between the driving surfaces and the driven surfaces 238.

The shaft 241 passes through the brake housing 231 along the third axis Z and is movably mounted within the brake housing 231 such that the shaft 241 is movable along the third axis Z as indicated by arrow M2 with respect to the brake housing 231 and the grabber bracket 119 on which the brake housing 231 is mounted. The brake shoe 237 includes braking surfaces 239 on an inner side thereof that face the shaft 241. That is, as shown in FIG. 4, the shaft 241 passes between the braking surfaces 239.

When the brake driver 235 moves downward, the driving surfaces 236 press against the driven surfaces 238 of the brake shoe 237 and, due to the inclination of the driving surfaces 236 and the driven surfaces 138, the brake shoe 237 is pushed inward along the radial direction, decreasing a second gap G2 between the braking surfaces 239 until the second gap G2 is equal to an outer diameter of the shaft 241 and the braking surfaces 239 push against the shaft 241 with an inward force along the radial direction, thereby immobilizing the shaft 241 with respect to the brake shoe 237. Thus, the braking structure 233 is able to selectively lock the shaft 241 and the suction head assembly 210 with respect to the carrier frame 110 along the third axis Z. The braking structure 233 is configured to lock the shaft 241 along the third axis Z when the suction head assembly 210 is in a desired position.

The biasing member assembly 220 includes a biasing member 221 disposed around the shaft 241 between the upper surface 214 of the pivot plate 213 and the grabber bracket 119. The biasing member 221 may be, for example, a coil spring.

Prior to the suction head assembly 210 coming in contact with the vehicle component 50, the brake driver 235 is in a raised configuration such that the shaft 241 is movable with respect to the brake housing 231, and the biasing member 221 maintains the shaft 241 in a lowermost position along the third axis Z. When the robot arm assembly 90 moves the carrier assembly 100 atop the vehicle component 50 and is lowered to a position for grabbing the vehicle component 50, the sealing end 212 of the suction head 211 abuts the surface 50a of the vehicle component 50. Depending on a geometry of the surface 50a of the vehicle component 50, the pivot plate 213 may pivot about the swivel joint 215 and/or the suction head 211 structured as bellows may deform to conform to the surface 50a. As the carrier assembly 100 is lowered, the surface 50a of the vehicle component 50 pushes the suction head assembly 210 upward along the third axis Z such that the shaft 241 moves upward with respect to brake housing 231, compressing the biasing member 221 between the grabber bracket 119 and the pivot plate 213. Once the carrier assembly 100 has reached its desired position with respect to the vehicle component 50, the braking structure 233 within the brake housing 231 locks the shaft 241 such that the shaft 241 is immovable with respect to the brake housing 231. The fluid suction mechanism 260 may be turned on to vacate air from within the suction head 211 through the pivot plate 213 and the shaft 241 such that the suction head 211 grabs the surface 50a of the vehicle component 50 via the vacuum forces. Thus, the grabber assemblies 200 grab the surface 50a of the vehicle component 50. The grabber assemblies 200 may thereby prevent sagging of the vehicle component 50. As shown in FIG. 4, the controller 80 may be connected to the fluid suction mechanism 260 to control the fluid suction mechanism 260, either automatically or in conjunction with operator input.

The grabber assemblies 200 may release the surface 50a of the vehicle component 50 when the fluid suction mechanism 260 is turned off. Once the surface 50a of the vehicle component 50 is released, the braking structure 233 may release the shaft 241, by, for example, moving the brake driver 235 upward. The braking structure 233 may include a biasing member (not shown) that biases the brake shoe 237 outward along the radial direction when the brake driver 235 is raised. The biasing member may be, for example, a spring. Once the shaft 241 is released by the braking structure 233, the biasing member 221 decompresses to push the suction head assembly 210 back to its lowermost position.

According to one or more embodiments, the grabber assemblies 200 may conform to different vehicle components 50 of different shapes and sizes and having different geometries of the surface 50a, allowing the grabber assemblies 200 to grab various vehicle components 50. Thus, a carrier assembly 100 having the grabber assemblies 200 according to one or more embodiments may eliminate the need for multiple carrier assemblies of differing shapes and sizes to accommodate differently shaped and sized vehicle components. Furthermore, a carrier assembly 100 having the grabber assemblies 200 according to one or more embodiments may improve efficiency by eliminating the need to switch out carrier assemblies to handle differently shaped and/or sized vehicle components.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on”another element, there are no intervening elements present.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A grabber assembly defining a first axis, a second axis perpendicular to the first axis, and a third axis perpendicular to the first axis and the second axis, the grabber assembly comprising:
a shaft extending along the third axis and defining a through-hole therein extending along the third axis;
a suction head assembly disposed on the shaft and comprising a suction head configured to form a seal against a surface of a vehicle component, the suction head being fluidly coupled to the through-hole of the shaft; and
a brake assembly movably supporting the shaft such that the shaft is movable along the third axis, the brake assembly comprising a braking structure that is configured to selectively immobilize the shaft along the third axis.

2. The grabber assembly of claim 1, further comprising a biasing member disposed between the suction head assembly and the brake assembly and configured to bias the suction head assembly away from the suction head assembly along the third axis.

3. The grabber assembly of claim 2, wherein the biasing member is a coil spring disposed around the shaft.

4. The grabber assembly of claim 1, wherein the through-hole of the shaft is fluidly coupled to a fluid suction mechanism that generates a vacuum force within the suction head.

5. The grabber assembly of claim 1, wherein the braking structure comprises a brake shoe disposed around the shaft and a brake driver disposed at least partially around the brake shoe.

6. The grabber assembly of claim 5,
wherein the grabber assembly defines a radial direction perpendicular to the third axis,
wherein the brake driver is movable along the third axis while immobile along the radial direction, and
wherein the brake shoe is movable along the radial direction while immobile along the third axis.

7. The grabber assembly of claim 6, wherein the brake driver comprises a driving surface, the brake shoe comprises a driven surface, and the driving surface is configured to press against the driving surface when the brake driver moves along the third axis.

8. The grabber assembly of claim 7, wherein the driving surface and the driven surface are inclined with respect to the third axis.

9. The grabber assembly of claim 6, wherein the brake shoe comprises a braking surface that faces the shaft and that is configured to push against the shaft along the radial direction to immobilize the shaft along the third axis.

10. The grabber assembly of claim 6, wherein the brake driver is coupled to an actuation mechanism configured to move the brake driver along the third axis.

11. The grabber assembly of claim 1, wherein the suction head is shaped as bellows.

12. The grabber assembly of claim 1, wherein the suction head assembly further comprises a pivot plate that is rotatably mounted on the shaft via a swivel joint.

13. The grabber assembly of claim 12, wherein the pivot plate is rotatable about the second axis.

14. The grabber assembly of claim 4, further comprising a controller configured to control the fluid suction mechanism and the braking structure.

15. The grabber assembly of claim 1, wherein the brake assembly comprises a brake housing in which the braking structure is mounted.

16. A carrier assembly defining a first axis, a second axis perpendicular to the first axis, and a third axis perpendicular to the first axis and the second axis, the carrier assembly comprising:
a carrier frame comprising a beam extending along the first axis and a grabber bracket extending from the beam along the second axis; and
a grabber assembly mounted on the grabber bracket, the grabber assembly comprising:
a shaft extending along the third axis and defining a through-hole therein extending along the third axis;
a suction head assembly disposed on the shaft and comprising a suction head configured to form a seal against a surface of a vehicle component, the suction head being fluidly coupled to the through-hole of the shaft; and
a brake assembly movably supporting the shaft such that the shaft is movable along the third axis, the brake assembly comprising a braking structure that is configured to selectively immobilize the shaft along the third axis.

17. The carrier assembly of claim 16, wherein the brake assembly comprises a brake housing in which the braking structure is mounted, the brake housing being mounted directly on the grabber bracket.

18. The carrier assembly of claim 16, wherein the shaft is movable along the third axis with respect to the carrier frame.

19. A carrier assembly comprising:
a carrier frame defining a first axis, a second axis perpendicular to the first axis, and a third axis perpendicular to the first axis and the second axis, the carrier frame comprising:
a first beam and a second beam extending along the first axis and spaced from each other along the second axis;
a first grabber bracket and a second grabber bracket extending from the first beam along the second axis and spaced from each other along the first axis; and
a third grabber bracket and a fourth grabber bracket extending from the second beam along the second axis and spaced from each other along the first axis; and
a first grabber assembly mounted on the first grabber bracket, a second grabber assembly mounted on the second grabber bracket, a third grabber assembly mounted on the third grabber bracket, and a fourth grabber assembly mounted on the fourth grabber bracket, each of the first, second, third and fourth grabber assemblies comprising:
a shaft extending along the third axis and defining a through-hole therein extending along the third axis;
a suction head assembly disposed on the shaft and comprising a suction head shaped as a bellows configured to form a seal against a surface of a vehicle component, the suction head being fluidly coupled to the through-hole of the shaft;
a brake assembly movably supporting the shaft such that the shaft is movable along the third axis, the brake assembly comprising a brake housing and a braking structure mounted in the brake housing that is configured to selectively immobilize the shaft along the third axis; and
a coil spring disposed around the shaft between the suction head assembly and the brake assembly and configured to bias the suction head assembly away from the suction head assembly along the third axis,
wherein the braking structure comprises a brake shoe disposed around the shaft and a brake driver disposed at least partially around the brake shoe,
wherein the grabber assembly defines a radial direction perpendicular to the third axis,
wherein the brake driver is movable along the third axis while immobile along the radial direction,
wherein the brake shoe is movable along the radial direction while immobile along the third axis,
wherein the brake driver comprises a driving surface, the brake shoe comprises a driven surface, and the driving surface is configured to press against the driving surface when the brake driver moves along the third axis,
wherein the driving surface and the driven surface are inclined with respect to the third axis,
wherein the brake shoe comprises a braking surface that faces the shaft and that is configured to push against the shaft along the radial direction to immobilize the shaft along the third axis, and
wherein the suction head assembly further comprises a pivot plate that is rotatably mounted on the shaft via a swivel joint so as to be rotatable about the second axis.

20. A carrier assembly of claim 19,
wherein the through-hole of the shaft is fluidly coupled to a fluid suction mechanism that generates a vacuum force within the suction head,
wherein the brake driver is coupled to an actuation mechanism configured to move the brake driver along the third axis, and
wherein the carrier assembly further comprises a controller configured to control the fluid suction mechanism and the actuation mechanism.
